(19) United States
(12) Patent Application Publication
(10) Pub. No.: US 2002/0061396 A1
(43) Pub. Date: May 23, 2002

(54) AEROGEL LOADED TILE COMPOSITE MATERIAL

(76) Inventor: SUSAN M WHITE, SUNNYVALE, CA (US)

Correspondence Address: NASA AMES RESEARCH CENTER, ATTN: PATENT COUNSEL, MAIL STOP 202A-3, MOFFETT FIELD, CA, 94035-1000, US

(21) Appl. No.: 08/971,443

(22) Filed: Nov. 17, 1997

(51) Int. Cl. B32B 27/12; D04H 1/00; D04H 3/00; D04H 5/00; D04H 13/00; B32B 17/12; B32B 18/00; B32B 27/04

(52) U.S. Cl. 428/293.4; 428/292.1; 428/297.4

(57) ABSTRACT

A composite material having a preferably rigid preformed ceramic fiber matrix at least partially impregnated with an aerogel and forming a multi-layered material. The matrix is impregnated with an aerogel material which forms a layer having a total thickness r where r is less than t or equal to t, where t is the thickness of the matrix, thus forming a single or multilayered composite material. The material may be formed with numerous layers s₁, s₂, S₃, . . . sₙn where r=Σsₙ and r is less than or equal to t. Thus, a multi-layered material is formed. Alternatively, the aerogel/fiber matrix composite has channels devoid of aerogel.

### ORIGIN OF THE INVENTION

The invention described herein was made by an employee of the United States Government and may be manufactured and used by or for the Government for governmental purposes without the payment of any royalties thereon or therefor.

### TECHNICAL FIELD OF THE INVENTION

This invention relates to lightweight insulation materials. More particularly, the present invention relates to single or multi-layered aerogel composites where the aerogel layer is formed inside a rigid preform by in situ techniques to produce a composite suitable for cryogenic applications, spacecraft applications, and the process to make such a layered material.

### BACKGROUND OF THE INVENTION

Ceramic fiber materials are used in a variety of applications such as spacecraft insulation, building and aircraft insulation and filtration. For example, Fibrous Refractory Composite Insulation (“FRCI”) shown in U.S. Pat. No. 4,148,962 by Leiser et al. is a rigid material made by sintering ceramic fibers together to form a highly porous, low density, low conductivity spacecraft insulation material. This type of material is known for high mechanical strength, toughness, and machinability.

Ceramic fiber materials such as Ll-900 and FRCI are used in space applications where refractory, low density, low conductivity, robust materials are needed for insulation. However, the highly permeable, micron-sized pores of these materials cause two problems: (1) the effective thermal conductivity of porous ceramic fiber materials is significantly higher under atmospheric conditions than it is under vacuum, because conduction and convection by the gas in the open pores of the material transports a significant amount of energy; and (2) ceramic fiber materials permit cryopumping: the continuous movement toward and condensation of oxygen or water vapor at cold surfaces. Cryopumping and condensation are a particularly serious problem for spacecraft cryogenic tanks where condensed water adds to the launch weight and where condensed oxygen could explode.

Pure aerogel materials, such as silica aerogel, are mechanically fragile but have extremely low conductivity, low permeability and low density. An aerogel has extremely small pores, typically on the order of 50 nanometers. As a result, mass and energy transported by gas convection though the aerogel material are reduced to a minimal value. Filling the open pores of a rigid ceramic fiber insulation material with aerogel solves these two problems of pressure-dependent conductivity and cryopumping, by restricting gas flow without significantly increasing weight or conduction. Even under atmospheric pressure, the aerogel significantly reduces the effective thermal conductivity of a highly porous ceramic fiber matrix such as FRCI to is minimum possible value, which is its effective conductivity under vacuum. Reducing the effective conductivity directly reduces the required insulation launch weight. Controlling cyropumping, on the other hand, allows rigid ceramic fiber insulation to be used in the important application of insulating reusable cryogenic tanks.

Matrix composites that combine aerogel and fibers are taught in U.S. Pat. No. 5,306,555 to Ramamurthi et al. which describes a completely aerogel-filled, flexible composite material where a bulk aerogel is reinforced by isolated or intertwined fibers as opposed to the layered or partially aerogel-filled continuous rigid high temperature ceramic matrix of the current invention. In U.S. Pat. No. 5,156,895 to Martin, aerogel materials completely fill isolated cells and reinforced on a macroscopic level, as opposed to a microscopic level, but the aerogel is not in a continuous phase. In U.S. Pat. No. 5,569,513 to Fidler and Simonton, aerogel precursors and gelatin are mixed and gelled together to form a low-temperature, non-rigid, one-layer composite.

Thus a need exists for an insulative material that avoids the drawbacks and disadvantages of the prior art. Such a need is met by a multi-layered composite described in the present invention which comprises a preferably rigid, preformed porous ceramic matrix and at least one aerogel layer.

### SUMMARY OF THE INVENTION

The present invention relates to a composite containing, a fibrous ceramic matrix, preferably rigid, which is at least partially impregnated with an aerogel thereby forming a layered material.

The multi-layered aerogel composite of the present invention is intended to be used as a robust machinable spacecraft and cryogenic tank insulation material. The multi-layered composite will provide a single insulative material which will serve over an entire space mission, as opposed to using two separate insulative materials for cryogenic and high temperature applications. The multi-layered composite will insulate, and prevent condensation of air or water during cryogen tankage and ground-hold of a launch vehicle. The composite will function as improved high-temperature insulation during vehicle reentry.

This integrated TPS/cryogenic insulation will eliminate adhesive bonding or mechanical attachment between an external high temperature insulation and a dedicated cryogenic insulation, thereby eliminating complicated, expensive installation, inspection and verification procedures. The multi-layer composite of the present invention may also be used for filtration or catalysis purposes.

An object of the invention is to provide and produce a composite material which has high mechanical strength, low conductivity, low permeability, low density and is moisture resistant and machinable.

A still further object is the in situ formation of at least one aerogel layer of lesser thickness than that of the composite in a preferably rigid matrix.

Another object of the invention is to provide and produce a composite material that decreases convection and conduction without greatly increasing density.

Another object of the invention is to provide and produce an insulation material which is suitable for cryogenic conditions and is fire-resistant.

Yet another object of the invention is to provide and produce a multi-layered insulation material where at least one layer serves to control micro-convection, and gas condensation.

A further object of the invention is to provide a composite which has at least two spaced apart aerogel layers in a ceramic composite.

Another object is to provide a process for preparing a ceramic fiber matrix impregnated with aerogel.

Other objects, features and advantages of the invention shall become apparent when considered in connection with the accompanying illustrative drawings, detailed descriptions, non-limiting examples and claims.

### BRIEF DESCRIPTION OF THE DRAWINGS

FIG. 1 is a exploded cross-sectional view of a fibrous composite having at least one in situ formed aerogel layer in accordance with the present invention.

FIG. 2 depicts the graphical relationship of the reduction in thermal conductivity of aerogel loaded FRCI (AETB-8) verses temperature.

FIG. 3 is a graph showing back-wall or cold-face temperature for a multi-layer aerogel ceramic tile composite, subjected to a heating profile representative of the Space Shuttle Orbiter. FIG. 3 also shows the bondline temperature, that is, the temperature where the external insulation such as a tile is bonded to the outer shell of a spacecraft.

FIGS. 4a, 4b, 4c and 4d show the surface and internal temperatures of four composites of this invention. The temperatures were taken at three locations during an arc jet reentry heating simulation performed at NASA Ames Research Center. The four composites are described later in Table 1.

FIGS. 5a-5c show the effect of different heating cycles on one aerogel/tile composite using NASA Ames Research Center Arc Jet facilities to perform spacecraft reentry simulation.

FIG. 6 shows the Infrared reflectances of four composites.

### DETAILED DESCRIPTION OF THE PRESENT INVENTION

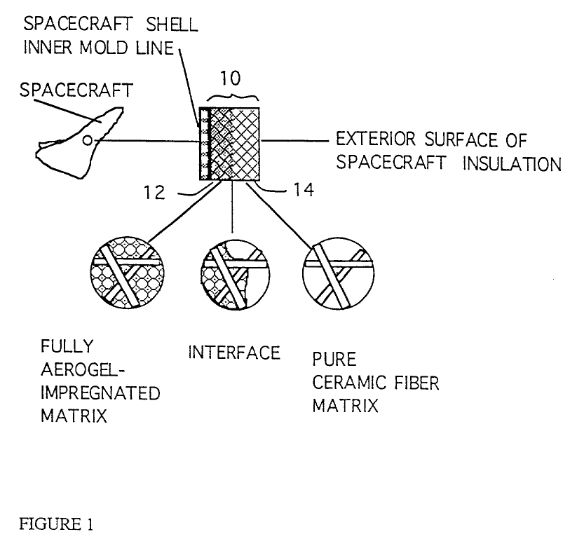

Referring to FIGS. 1-6, the present invention composite material comprises an aerogel impregnated into a rigid porous preform fiber ceramic matrix. The matrix may be premolded or machined. The matrix is at least partially impregnated with an aerogel precursor solution and processed to form at least one discrete aerogel layer within the matrix. Several aerogel layers are also within the scope of the invention, as are aerogel layers of the same or different composition. In one embodiment of the present invention, a silica aerogel is located in an aluminum-silicate fiber matrix.

The fiber dimensions are not particularly limited, although a fiber diameter of from 1 to 15 microns and length of the fibers from 0.3 to 1.5 cm can generally be employed.

Preferred fibers include silicon dioxide fibers, at least 99.6% pure, manufactured by Schuller and commercially available as Microquartz 108 fibers; Nextel 312 (an aluminoborosilicate or ABS fiber) produced by the 3M Company containing 62 +/−2% aluminum oxide, 14 +/−2% boron oxide, and 24 +/−2% silicon dioxide; Nextel 440 and 480 ABS fibers made by 3M; and aluminum oxide “Saffil” fibers made by ICI Americas Inc.

Other examples of suitable ceramic fibers for the fibrous ceramic substrate of this invention include Zircar® zirconium dioxide fibers (or felt); silicon nitride fibers, Nicalon® “Ceramic Grade” silicon carbide fibers manufactured by Nippon Carbon of Japan; Tyranno silicon carbide fibers made by Ube Industries of Japan; SCS-2,6,8 silicon carbide on carbon filaments made by Textron; Saphikon aluminum oxide fibers; Nextel Z11 zirconium silicate fibers made by 3M; Saffil aluminum silicate fibers made by I.C.I.; Altex aluminum silicate fibers made by Sumitomo; Almax aluminum oxide fibers made by Mitsui Mining; FP aluminum oxide fibers made by Du Pont; PRD-166 zirconium albuminate fibers made by Du Pont; HPZ on tungsten filaments made by British Petroleum; Fiberamic silicon carbide fibers made by Dow Corning; Sigma silicon carbide fibers made by Rhone-Poulenc; boron nitride fibers made by Electroceramics; carbon fibers made by Fiber Materials; and silicon carbide and silicon nitride whiskers.

The fibrous ceramic substrate of this invention may be prepared from the above described fibers, e.g., in accordance with the technique described in U.S. Pat. No. 4,148,962 to Leiser et al and U.S. Pat. No. 3,952,083 to Fletcher et al incorporated herein by reference.

Specific examples of fibrous ceramic substrates for use in this invention include the following:

1. AETB (Alumina Enhanced Thermal Barrier) developed by NASA Ames Research Center, Moffett Field Calif. AETB-8 has a density of 0.13-0.15 g/cc (8-9 lb*m/ft³), and AETB-12 has a density of 0.17-0.21 glec (11-13 16/ft³). AETB contains a varying wt % of Nextel® fibers, alumina fibers, silicon carbide fibers, and silica fibers. There are typically 94-95% voids in this substrate. For details of AETB-20, reference may be made to D. B. Leiser, M. Smith and D. A. Stewart, “Option for Improving Rigidized Ceramic Heat Shield”, Ceramic Eng. & Science Proceeding, Vol. 6, No. 7-8, Aug. 1985 or U.S. Pat. No. 4,148,962 to Leiser et al.

2. FRCI (Fibrous Refractory Composite Insulation) developed by NASA Ames Research Center, FRCI 12 has a density of 0.17-0.21 g/cc (11-13, lb*m/ft³ ), and contain Nextel® fibers, and silica fibers. There are typically 95-96% voids in this substrate. For details of FRCI reference may be made to D. A. Stewart and D. B. Leiser “Characterization of the Thermal Conductivity For Fibrous Refractory Composite Insulations” Ceramic Eng. & Science Proceeding, Vol. 6, No. 7-8, Aug. 1985 or U.S. Pat. No. 4,148,962 to Leiser et al.

3. LI made by Lockheed (Lockheed Insulation), LI-900 having a density of 0.12-0.15 g/cc (7.5-14 lb*m/ft³ ), and containing SiO₂ fibers only. There are 93-95% voids in this substrate. For details of LI-900 and LI-1500 reference may be made to Beasley et al “Fabrication and Improvement of LMSC's All-Silica RSI” Tech. Report NASA TMX-2719 (Nov. 1972).

4. AIM (AMES Insulation Material) developed by NASA AMES Research Center, AIM-10 having density of 0.15-0.17 g/cc (9-10 lb*m/ft³ ) and containing 98.5% ultra microquartz fibers and 1.5% silicon carbide. There are 92-94% voids in this substrate. This substrate was developed using a processing technique similar to that described in U.S. Pat. No. 3,952,083 to Fletcher et al.

5. Light weight rigid carbon tile, made by Fiber Materials Inc., commercially available as Fiberform®, having a density of 0.15-0.22 g/cc (9-14 lb*m/ft³ ), and containing carbon fibers only. There are 88-93% voids in this substrate. For details, reference may be made to U.S. Pat. Nos. 3,577,344 (May 1971), 3,393,204 (Feb. 1974) and 4,152,482 (Mar. 1978). 6. The aerogel that is incorporated into the rigid preform can contain: silica, alumina, titania, zirconia, magnesia, aluminum compounds (such as aluminum-silicate), carbon, resorcinol-formaldehyde, melamine-formaldehyde and phenolic compounds such as phenolic-furfural.

The composite material of the present invention uses a preferably rigid porous ceramic matrix having a predetermined thickness t. The ceramic matrix is impregnated with an aerogel material wherein at least one aerogel layer is formed having a total thickness r where r≦t, preferably r<t thus forming a single or multi-layered material. The invention also encompasses a composite having numerous aerogel layers having thicknesses s1, S2, S3, . . . sₙ, where r=sₙ and r≦t, preferably r<t thus forming a single or multi-layered material.

FIG. 1 illustrates a cross-section of a two-layered embodiment of the invention which is attached to a craft at the shell thereof. Layer or matrix 10 is an open-pored rigid framework of ceramic or carbon fibers where the pores are interconnected and filled with air. The specific fibers are carbon silica and alumina silicate. In layer 12 the open, connected pores of the matrix are completely impregnated with the aerogel.

The aerogel-impregnated matrix layer 12 has two primary functions: (1) providing cryogenic insulation; or (2) lowering the conductivity of the matrix under atmospheric pressure by preventing air or water vapor movement through the otherwise-porous ceramic fiber matrix to its minimum possible value of a tile under vacuum.

### PREPARATION METHOD

Several alternate methods of preparing the aerogel composite material of FIG. 1 are herein described. First, a porous ceramic matrix 14 such as a silicate fiber matrix was produced according to conventional techniques such as those taught in U.S. Pat. No. 4,610,863. An aerogel precursor solution was then prepared from two solutions A and B, which when mixed, initiated the reactions leading to the formation of a gel. Gelation occurred spontaneously upon mixing and did not require heat. In fact for certain aerogels, the additional heat produced is substantial enough to require cooling. The gelation reaction rate depended upon the concentration of solutions A and B. The molar ratios of the mix were determined for a targeted final density of the dried aerogel. Generally the range is from 0.01 g/cc to 200 g/cc. The amounts were determined by the volume needed to fill the preforms. For example, 90 cc of the mixture was required to fill a 100 cc piece of a matrix having 90% porosity. This step was performed at room temperature and at atmospheric pressure.

For example, for a target density of 50mg/cc, solution A contained silicon alkoxide (tetramethoxysilane - TMOS) and alcohol (methanol) in the molar ratio, 0.4:7.5. Solution B contained methanol, water, and ammonium hydroxide in molar ratio, 7.5:1.6:0.009. Solutions A and B in weight ratio 100:81 were poured into a common glass container and stirred for 15 minutes.

Thereafter the matrix was partially infiltrated with the precursor solution. The preform matrix was placed in a vessel and the precursor mixture was added thereto. The liquid pre-gel formed from the precursor solution filled the void space in the pre-form by capillary flow (vacuum assisted) and the subsequent boiling helped to remove trapped gases. The volume of the mixture was sufficient to totally immerse the pre-form when it sinks. The vessel containing the matrix and precursor was then placed in a vacuum chamber. The pressure in the chamber was reduced until the mixture started to boil, and then maintained at that pressure for five minutes before being slowly increased back to atmospheric pressure.

The vessel was then removed from the vacuum chamber and was immediately covered or sealed with a low permeability wrap, and stored on a bench top. The solution gelled anywhere from less than 1 hour to 40 hours depending on the targeted density. The vessel was kept covered during this time.

The impregnated matrix was then subjected to supercritical drying. The vessel was placed inside an autoclave capable of operating at pressure of at least 1400 psi and a temperature of at least 300 degrees C. An additional volume of alcohol, at least equal to 1/10 the volume of the autoclave, was added to the autoclave before sealing it. The temperature of the autoclave was then raised at a rate of 0.5 degrees C. per minute, to a maximum temperature of 300 degrees C. The pressure in the autoclave rose to a maximum of 1400 psi and is regulated at that pressure by a pressure relief valve.

Once the temperature had reached 300 degrees Celsius and the pressure was at least 1400 psi, the mother liquid transformed under supercritical conditions to a gas, and was removed by venting. The pressure was then slowly released from the vessel at a rate not exceeding 5 psi per minute, while the temperature was held constant. After the pressure dropped to about 20 psi the heaters were turned off and the vessel was purged with dry air while it cooled. The aerogel-filled pre-form was removed from the vessel after it has cooled sufficiently (usually after 6 hours). Note that the host liquid (mother liquid) evaporated when the matrix was heated and pressurized to supercritical conditions.

Drying was done by supercritical fluid extraction but can upon further development of the art be done by minimizing surface tension during evaporation. Supercritical fluid extraction can also be done after the alcohol has first been replaced by another liquid such as carbon dioxide having a lower critical temperature.

Finally to create a multi-layered material with the top layer composed of fibers and the lower layer composed of the fiber/aerogel composite material, heat was applied to the top surface of the matrix to sinter back the aerogel surface inside the preformed ceramic matrix. In this process, sintering was the process of applying heat to the composite thus causing coalescence of the highly porous aerogel into a fully dense solid mass which occupies orders of magnitude less volume, thus the aerogel shrinks and condenses around the fibers of the matrix. For example, after sintering at 1000 degrees Celsius and atmospheric pressure, a typical aerogel with density 0.1 g/cc and a solid volume fraction of approximately 5%, shrinks to 5% of its previous volume, leaving 95% open porosity inside the matrix.

When the composite material is used as spacecraft insulation, the preferred method of performing the sintering step is to attach the fully impregnated insulation material to the spacecraft, and use the re-entry heating to sinter back the aerogel inside the matrix. This optimizes the layer's thickness, leaving the maximum aerogel-filled layer intact.

During the first reentry experienced by the material, that is, when the spacecraft enters a planetary atmosphere and slows down, the extreme heating produced is partly absorbed by the process of sintering the aerogel. The reentry heat is caused by friction as the craft reenters the Earth's atmosphere. These reentry conditions can be simulated with Arc-jet testing. Sintering is used here in the sense of coalescence upon heating.

The aerogel starts as an extremely low-density, microporous material. Upon sintering it changes from an aerogel to a high density material, which occupies much less volume, forming a thin coating on the fibers and occupying the junctions between the fibers. After sintering, the composite material has open spaces between the fibers in the sintered layer, rather than aerogel.

For example, silica aerogel in a matrix sinters to become a silica coating on the fibers or between the fibers. Sintering will occur only in the outermost section of the spacecraft insulation wherever the temperature exceeds the sintering temperature of the aerogel for sufficient time, e.g. standard silica aerogels will be fully sintered after being held 2 hours at 1000 degrees C, but will withstand any duration of heating at 200 degrees C. This sintering of the outermost layer has been demonstrated in Arc-Jet test at NASA Ames. The preferred method is to use reentry heating during an actual spacecraft's mission, because this leaves the maximum thickness of the aerogel-loaded tile intact for the given mission, and there is no cost or additional work involved. Thus, this step forms a layer of thickness s within the fibrous matrix.

Layered sintering could be carried out using a blow torch, heat lamp or other heating method such as arc jet reentry simulation, wherein the heat is applied to the top surface.

A variation of this method involves first supercritically drying the fully loaded aerogel matrix and then using a laser to heat the aerogel locally. The laser can be used to create a pattern in the aerogel or to burn off a layer of the aerogel inside the matrix. An acid such as HF (hydrofluoric acid) could also be used to etch a pattern once the material is supercritically dried. A benefit of these processes is that they are fairly simple to perform.

Another method for creating a thin aerogel-free layer in the composite is to first supercritically dry the aerogel loaded composite material and then shoot particles at the surface of the material. The particles should be smaller than the size of the matrix's pores. For example, if the pores of the matrix were approximately ten microns, then particles the size of one micron could be shot at the surface of the matrix. The particles would fit inside the pores and break up the aerogel structure at the surface. After the particles broke up some of the surface a blower with compressed air could be used to blow away the pieces of aerogel. This is an alternate way to create the layers or etch a pattern into the surface of the aerogel.

Alternative methods of forming a multi-layered composite require creating the layers before the aerogel precursor is supercritically dried inside the matrix to form an aerogel.

The preferred method of forming a two-layered composite before drying the aerogel precursor depends on how strongly capillary forces suck or wick the aerogel precursor solution into the matrix. A strongly wicking material such as AETB or FRCI, can be put in a container with only enough aerogel precursor to partially fill the matrix. A weakly wicking matrix material can be placed in a container with the aerogel precursor filling the container to the desired depth, gelled in place, and excess gel trimmed. Then the composite is then processed to form an aerogel.

An alternative method for creating the layers in the composite material before drying the aerogel precursor involves partly filling the rigid matrix with a liquid that forms a solid material such as wax or a polymer resin such as PMMA (polmethylmethacrylate) before the aerogel impregnation step. For example, the wax or resin can be introduced into one part of the matrix and cooled or cured in place to leave the solid wax or polymer filling all the pores of that one section. If desired, at this stage the wax or polymer could be burned out of the outer section of that solid section, leaving a sandwich-structure matrix, which is filled in the middle with a layer of wax or polymer, and devoid of wax or polymer in the outer sections. This two-layer or sandwich matrix is next filled with the aerogel solution. Then the aerogel is allowed to gel inside the unfilled part of the matrix. The aerogel is next dried inside the fully impregnated matrix, typically by supercritical drying in an autoclave. Because wax melts at a low temperature, e.g. 69 degrees C. for beeswax, supercritical drying would be accomplished using carbon dioxide at 30 degrees C. Higher-temperature resins such as PMMA which burn out at 550 degrees C., will withstand supercritical drying with alcohol, typically at 300 degrees C. The final step involves melting or burning out the wax or resin with surface heating or in an oven, to leave a multi-layered composite.

Another method involves taking a matrix that has been fully impregnated with aerogel precursor solution, and subjecting the matrix to a jet of water or jet of solvent solution. The jet of water or solvent is used to dissolve the top layer of aerogel inside the matrix. The jet could also be used to etch a pattern in the aerogel. The matrix is then supercritically dried.

Yet another alternative method uses a centrifuge to spin the precursor-impregnated matrix to confine the aerogel solution to the outer part of the matrix during the gelation stage. After gelation has occurred, the wet gel will remain in place, and the partly impregnated matrix can be removed from the centrifuge. It is then processed to supercritically dry the aerogel. The centrifuge is used here to overpower the capillary force which otherwise allows the aerogel precursor to wick though the matrix.

### DATA

Table 1 shows four different composites that have been tested extensively.

TABLE 1
Matrix of Aerogel Composites

| Composite | 8-1 | 8-2 | 12-1 | 12-2 |
|---|---|---|---|---|
| Aerogel | Silica | Silica | Silica | Silica |
| | Aerogel | Aerogel | Aerogel | Aerogel |
| | 0.1 g/cc | 0.2 g/cc | 0.1 g/cc | 0.2 g/cc |
| | (6.4 lb/ft³) | (12.8 lb/ft³) | (6.4 lb/ft³) | (12.8 lb/ft³) |
| Ceramic | AETB-8 | AETB-8 | AETB-12 | AETB-12 |
| Matrix | 0.13 g/cc | 0.13 g/cc | 0.19 g/cc | 0.19 g/cc |
| | (8 lb/ft³) | (8 lb/ft³) | (12 lb/ft³) | (12 lb/ft³) |

The silica aerogel component had a density of 100 g/cc in samples 8-1 and 12-1, and had a density of 200 g/cc in samples 8-2 and 12-2. The rigid fiber matrix used was a type of FRCI tile known as AETB, an acronym for Alumina Enhanced Thermal Barrier. These samples were submitted to arc-jet testing to create the layered composite material. Before arc-jet testing, the matrix was completely filled with the aerogel. During arc-jet testing, the high surface heating caused the aerogel to sinter back away from the heated surface into the matrix, leaving a two-layer composite as planned, where the top layer was composed of fibers and the bottom layer was composed of the aerogel/tile composite.

Table 2 shows the thermal conductivity for four Silica aerogel/AETB Tile composites.

TABLE 2
Thermal Conductivity Measurements for Four
Anisotropic Composites

| | 8-1 | 8-2 | 12-1 | 12-2 |
|---|---|---|---|---|
| Temp. | TRANS- | TRANS- | TRANS- | TRANS- |
| (Celsius) | VERSE | VERSE | VERSE | VERSE |
| 20 | 0.076 | 0.056 | 0.066 | 0.049 |
| 200 | 0.068 | 0.038 | 0.047 | 0.037 |
| 300 | 0.077 | 0.054 | 0.059 | 0.047 |
| 400 | 0.092 | 0.075 | 0.087 | 0.060 |
| 500 | 0.099 | 0.077 | 0.097 | 0.079 |
| Temp. | 8-1 | 8-2 | 12-1 | 12-2 |
| (Celsius) | INPLANE | INPLANE | INPLANE | INPLANE |
| 20 | 0.090 | 0.068 | 0.078 | 0.072 |
| 200 | 0.090 | 0.057 | 0.071 | 0.062 |
| 300 | 0.099 | 0.067 | 0.083 | 0.073 |
| 400 | 0.123 | 0.091 | 0.118 | 0.041 |
| 500 | 0.138 | 0.103 | 0.129 | 0.092 |

The AETB matrix itself is an anisotropic material having a lower thermal conductivity in one direction than in the other direction. Because the composite is also anisotropic, two values for the conductivity of the composites were measured, corresponding to the “Transverse” direction and the “In-Plane” direction. The conductivity was calculated from measurements were made with the Laser Flash Diffusivity Method. The accuracy of this method is estimated at +/−10% at room temperature, and +/−20% at the higher temperatures.

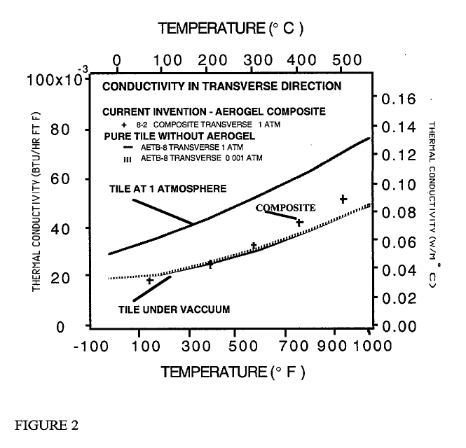

FIG. 2 displays experimental data obtained using flash thermal diffusivity measurements of two different composites formed from AETB tile and silica aerogels. The graph illustrates and compares two silica aerogel/AETB-8 composite material samples under atmospheric pressure to AETB-8, a variety of FRCI, in a vacuum and at atmospheric pressure. The thermal conductivity for the “in-plane” and the “transverse” directions is shown to be significantly lower for AETB-8 under vacuum (i.e. at 0.001 atmospheres), than at 1 atmosphere pressure. At lower temperatures, the data points for the composite materials follow the curve for the AETB-8 under vacuum, although the composite material measurements were made under 1 atmosphere pressure. The graph shows that after the temperature was increased to the sintering temperature for the aerogel, the conductivity jumped from the “vacuum” value to the value at 1 atmosphere above which the composites exhibited the conductivity of the AETB-8 material at atmospheric pressure. This indicates that below a certain use temperature at atmospheric pressure the silica aerogel AETB-8 composite material exhibits the reduced conductivity of pure AETB-8 under a vacuum.

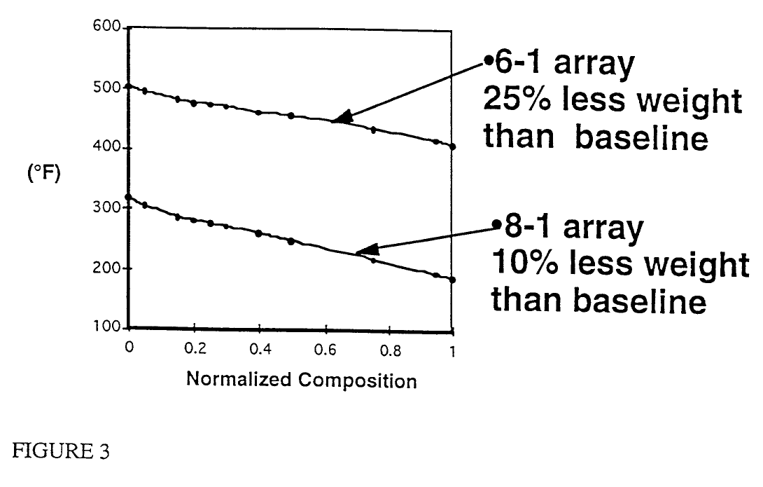

FIG. 3 shows the bondline temperature, that is, the temperature where the external insulation such as a tile is bonded to the aluminum outer shell of a spacecraft. In FIG. 3, an aerogel composite fraction (normalized composition) of zero refers to the pure refractory ceramic material. A composite fraction of one refers to a low-density aerogel filling the entire thickness of the refractory fibrous ceramic material. Aerogel composite fractions between zero and one refer to the lower fraction of the material being filled (from the backwall out). Calculations for a composite fraction of one, a completely filled matrix, show the material functioning as if fully under vacuum, that is, the effects of gas conduction and convection are minimized.

For spacecraft like the space shuttle using insulation attached with adhesive, it is critical to keep the bondline below the softening temperature of the adhesive used, typically 460 degrees F. For this reason, the bondline temperature for a standard thickness is one useful measure of the performance of an insulation material. For this comparison, the baseline or standard used is a 2 inch thick layer of a Space Shuttle baseline tile material known as LI900, which has a density of 9 lb/ft³, which controls the bondline temperature to roughly 330 degrees F when subject to a standard Space Shuttle heating profile. The calculations were made for two arrays of 2 inch thick slabs of multi-layered aerogel/rigid ceramic matrix composites. Array 8-1 is a set of two layer composites, formed from a rigid matrix having a density of 8 lb/ft³, partly filled with aerogel. The lower axis, Normalized Composition, shows what fraction of the lower part of the matrix is filled by the aerogel phase. Array 6-1 is a set of two layer composites, formed from an 6 lb/ft³ rigid matrix, partly filled with aerogel. For example, at the normalized composition of 0.2, the bottom 20 percent or 0.4 inches of the rigid matrix is filled with aerogel. The calculations showed that sufficiently low bondline temperatures could be maintained with these composite materials, and that the composites of the current invention would weigh less than the baseline LI900 material, even when completely filled with the aerogel.

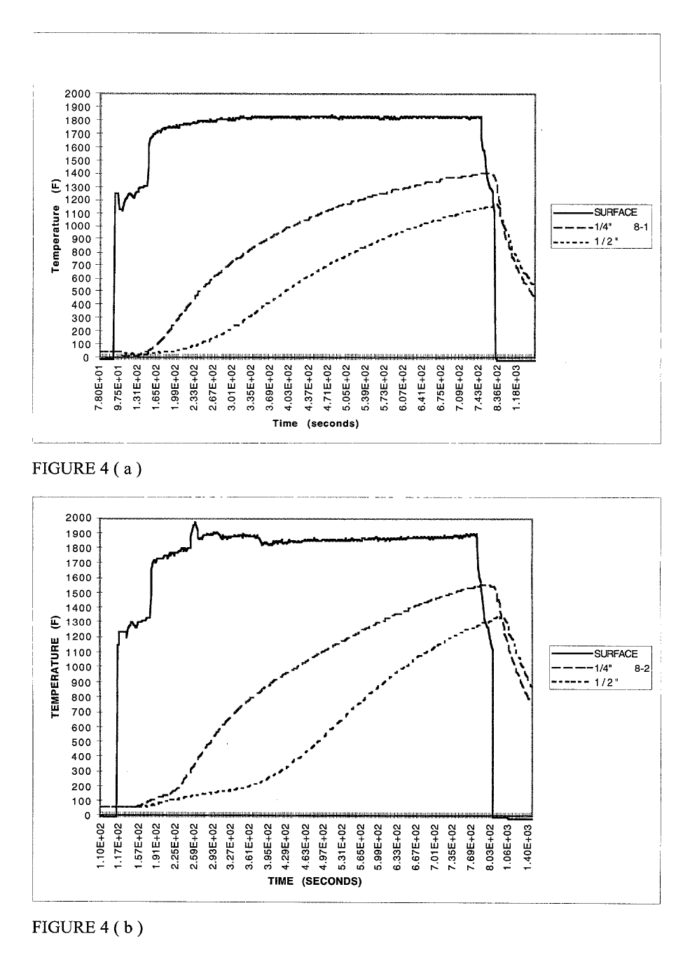

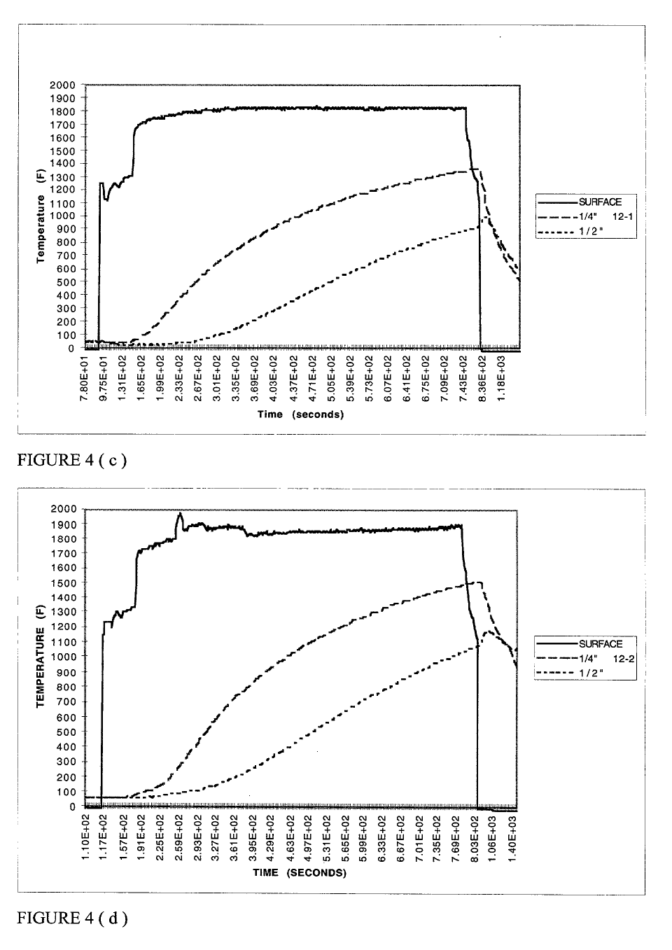

FIGS. 4a, 4b, 4c and 4d show the temperatures on the surface and inside four composites of this invention at three locations during arc jet reentry heating simulation tests performed at NASA Ames Research Center. The four composites are those described in Table 1. To simulate a moderate 12 Btu/Ft² sec reentry heating profile, the surface temperature was driven to approximately 1840 degrees F and held for 600 seconds. The surface temperature was measured with an optical pyrometer, and the in-depth temperatures at 1/4 inch and 1/2 inch from the heated surface were measured by thermocouples. FIG. 4a shows the results of a test on composite 8-1. FIG. 4b corresponds to the test on composite 8-2. FIG. 4c corresponds to the test on composite 12-1. FIG. 4d shows the results of a test on composite 12-2.

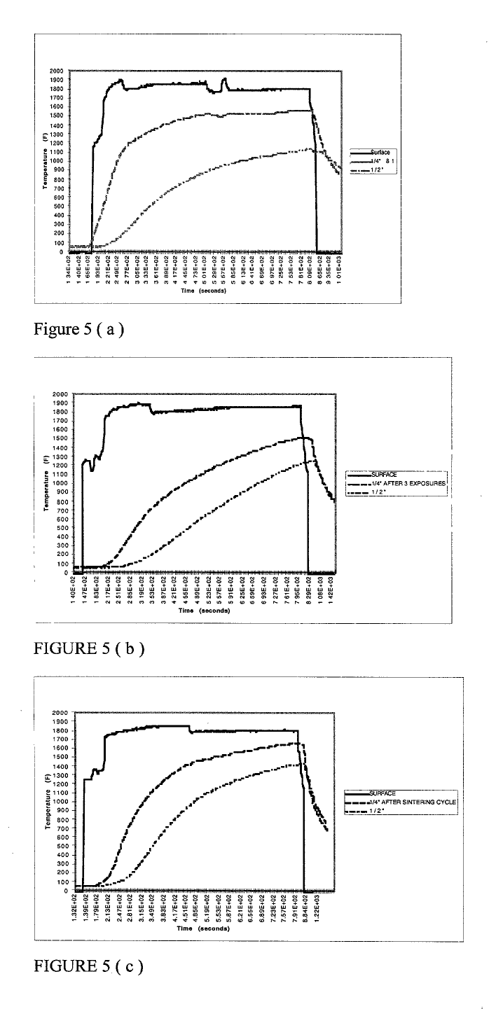

FIGS. 5a-5c show the effect of different heating cycles on one aerogel/tile composite subject to a series of reentry simulations at the NASA AMES Research Center. The test specimen, the composite labeled 8-1, was composed of AETB-8 tile, a version of FRCI tile, fully loaded at the start of testing with Silica Aerogel having a density of 100 g/cc. FIG. 5a shows the surface temperature and the response of thermocouples embedded at 1/4 inch and 1/2 inch from the surface of a test specimen in composite 8-1 after one surface heating cycle, wherein the surface attained a relatively low temperature for a spacecraft entry heating simulation of 1850 degrees Fahrenheit, held for 600 seconds.

FIG. 5b shows the thermal response of the material is nearly unchanged after three cycles in this relatively benign heating environment. The specimen was then subjected to one cycle of more extreme heating (not shown), during which the surface temperature was driven to 2030 degrees Fahrenheit for 600 seconds, in order to sinter the aerogel in the upper part of the test specimen and create a two-layer composite in the preferred method of using spacecraft atmosphere entry heating to sinter back the aerogel in the top surface.

FIG. 5c illustrates the change in the thermal response of the two-layer composite formed from the same test specimen 8-1 during a cycle of benign heating (surface temperature attaining 1830 degrees fahrenheit.) Examination under a scanning electron microscope confirmed that the aerogel had sintered in the top layer of the test specimen.

Comparing FIGS. 5a and 5b with FIG. 5c, the lower temperatures attained by the thermocouples in response to approximately the same surface heating proves that the aerogel-impregnated composite has a lower effective thermal conductivity than the sintered layer of the two-layer specimen in FIG. 5c, due to the aerogel's filling the voids in the tile and suppressing gas convection and conduction. Once the aerogel has sintered, it no longer fills the voids of the tile and can no longer suppress gas conduction or convection. For insulation applications, it would theoretically be preferable by prevent sintering, in order to keep the void space filled with aerogels to lower the effective conductivity, but it is only critical to do so to prevent condensation in the lower-temperature regions used for cryogenic applications. For the higher-temperature layer of a spacecraft insulation tile, a cost-benefit tradeoff may dictate the use of either more expensive, more refractory aerogels in hotter regions of the tile, such as Titania rather than Silica aerogels, or else of leaving the hotter zone unfilled by aerogels.

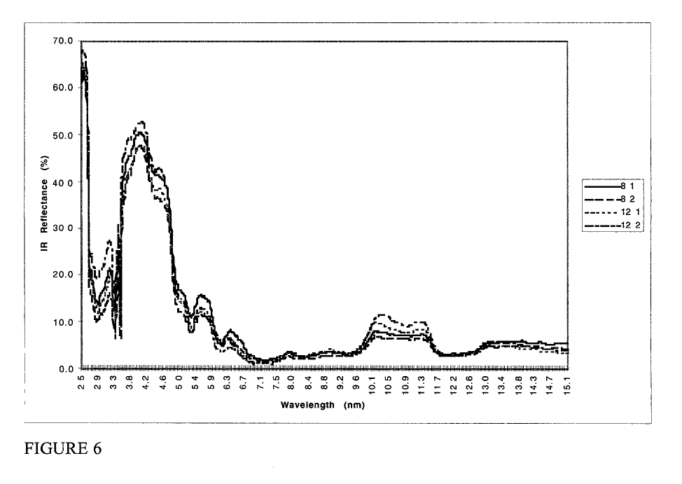

FIG. 6 shows the Infrared Reflectance of the four composites 8-1, 8-2, 12-1 and 12-2. The infrared reflectance indicates how efficiently an opaque materials reflects or emits infrared radiation. Aerogels are generally transparent in certain regions of the infrared, but the matrix is opaque in those regions, effectively “closing the infrared windows of transmittance” for the composites of this invention.

While advantageous embodiments have been chosen to illustrate the invention, it will be understood by those skilled in the art that various changes and modifications can be made therein without departing from the scope of the invention as defined in the appended claims.

claims:

1. A composite material comprising a rigid preformed ceramic fiber matrix having a predetermined thickness t, said matrix containing therein at least one layer of an aerogel having a total thickness r where r≦t, thus forming a multi-layered or single-layered material.

2. A composite material according to claim 1 wherein the aerogel comprises at least one component, said components is silicon, aluminum, titanium, zirconium, magnesium, aluminum compounds, or oxides thereof.

3. A composite material according to claim 1 wherein the aerogel contains carbon, resorcinal-formaldehyde, melamine-formaldehyde or phenolic compounds.

4. A method of preparing a multi-layered composite material comprising:
applying heat to the surface of an aerogel loaded fibrous matrix to sinter back the aerogel surface inside the fibrous matrix thereby forming a matrix having an aerogel layer of lesser dimension than that of said fibrous matrix.

5. The method according to claim 4, wherein the heat applied to the surface of the aerogel loaded fibrous matrix is a frictional heat created by atmospheric reentry of a spacecraft using the aerogel-loaded matrix as a thermal protection material.

6. A method of preparing a multi-layer composite comprising placing a rigid preform containing voids in a container holding sufficient aerogel precursor solution to fill the voids in a layer of the required thickness inside the matrix, followed by processing the composite to leave a two-layer material.

7. A method of preparing a multi-layered composite material comprising:
a. completing filling pores of a rigid preform matrix with an aerogel; and
b. dissolving the aerogel from the matrix in a layer or pattern of channels by using a bath or a jet of solvent that preferentially dissolves the aerogel or else by shooting a stream of hard particles smaller than the pore size of the rigid preform matrix to break the aerogel where particles impinge on the aerogel.

8. A method of preparing a multi-layer composite material comprising:
a. partially filling a fibrous matrix with a barrier material;
b. infiltrating the fibrous matrix with an aerogel precursor solution, said precursor solution including a host solution;
c. aging the precursor solution inside the matrix until the solution is gelled; and
d. removing the barrier material thereby leaving an aerogel layer of lesser dimension than that of said matrix.

9. A method of preparing a multi-layered composite:
a. completely filling a matrix preform with an aerogel precursor solution and gelling the solution in place;
b. rinsing away one or more outer layers of the gel or removing the gel in a pattern by directing a stream of water or other solvent at the composite; and
c. extracting the host solution leaving a partly-aerogel-filled matrix.

10. A method of limiting gas convection and condensation on a cold structure comprising locating a composite aerogel loaded ceramic matrix having a predetermined thickness t in insulating relationship with the structure, said matrix containing therein at least one layer of an aerogel having a total thickness r where r≦t.

11. A medium for filtration or catalysis, using a porous ceramic matrix having a predetermined thickness t, said matrix containing therein a layer of an aerogel having a total thickness r where r≦t, thereby forming a single or multi-layered material.

12. A method according to claim 9, wherein step (a) involves centrifuging the filled matrix during gelation.

13. The method according to claim 4, wherein the heating is supplied by a laser, which could sinter a layer of aerogel or sinter a pattern in the aerogel embedded in the matrix.
